(19) United States
(12) Patent Application Publication
(10) Pub. No.: US 2010/0157938 A1
(43) Pub. Date: Jun. 24, 2010

(54) METHOD AND APPARATUS APPLIED TO IDENTIFICATION FOR HANDOVER BETWEEN WIRELESS COMMUNICATION NETWORKS

(75) Inventors: Xiaohui Jin, Shanghai (CN); Bo Liu, Shanghai (CN); Xiaoling Shao, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/993,307

(22) PCT Filed: Jun. 28, 2006
(86) PCT No.: PCT/IB06/52147

§ 371 Date: Dec. 20, 2007

(30) Foreign Application Priority Data
Jun. 30, 2005 (CN) 200510081444.3

(51) Int. Cl. H04W 36/00

(52) U.S. Cl. 370/331

(57) ABSTRACT

The invention provides a method and apparatus to be executed in a first UE (User Equipment), applied to identification for handover from a current serving network to a target network, the method comprising the steps of: acquiring handover status information for a second UE communicating with it; and sending identity confirmation information to the second UE according to the handover status information so that the second UE can validate its identity, wherein the handover status information and the identity confirmation information are transmitted via different networks. With the proposed method and apparatus, the handover procedure between two wireless networks can be facilitated even in the case of not providing identification information of the calling party of the handover call.

### FIELD OF THE INVENTION

The present invention relates generally to wireless communication systems, and more particularly, to method and apparatus applied to identification for handover between different wireless communication networks.

### BACKGROUND OF THE INVENTION

With development of wireless communication technologies, many kinds of wireless networks emerged to provide various featured services.

For example, WLANs (Wireless Local Area Network) deployed in so-called hotspots such as airport, hotel or the like, may provide data service, VoIP (Voice over Internet Protocol) service or the like. People can use wireless terminals, such as mobile phones or laptops, to access the network resources in WLANs and the networks (such as Internet) connected thereto via wireless access. Furthermore, they can obtain multimedia services, such as video conversation. Additionally, other wireless networks, such as Bluetooth, WiMAX (Worldwide Interoperability for Microwave Access), UWB (Ultra Wideband) and the like, can provide various services as well.

Cellular networks, such as GSM (Global System for Mobile communication), GPRS (General Packet Radio Service), CDMA (Code Division Multiple Access), 3G mobile communication systems or the like, can provide various services mainly as voice communication. Since a cellular network may cover a larger area, it's categorized into the field of WWAN (Wireless Wide Area Network).

FIG. 1 illustrates a conventional application of two kinds of wireless networks, for example, WLAN and WWAN. As shown in FIG. 1, A WWAN service area may or may not overlay a WLAN service area. If two UEs (User Equipments) communicating via WWAN service enter into a WLAN service area due to change in positions, they may switch from WWAN service to WLAN service, to save radio resources in WWAN, and reduce the communication cost for the two communicating parties, and provide to users richer services, such as video conversation and etc. When one of the two parties communicating with WLAN service leaves the WLAN service area, the conversation switches back to WWAN service from WLAN service, to guarantee the continuity of the communication.

A communication method and apparatus capable of performing handover between WWAN and WLAN is described in the patent application Serial No. 03124909.4, entitled “Communication method and apparatus capable of performing handover between WWAN and WLAN” filed by KONINKLIJKE PHILIPS ELECTRONICS N.V. on Sep. 19, 2003, which is incorporated here by reference. With this method and apparatus, seamless roaming between WWAN and WLAN can be realized and it can further reduce the user's communication cost and save network resources in WWAN effectively.

FIG. 2A and FIG. 2B illustrate two methods for transferring from WLAN to WWAN as disclosed in the patent application 03124909.4. Here, one party initiating the handover process is termed as handover initiator UE and the peer UE communicating with it is termed as handover receiver UE.

As shown in FIG. 2A, when a handover initiator UE communicating with its peer UE via a WLAN interface (step S30) wants to transfer to WWAN to continue communication, it sends a WWAN call to the handover receiver UE via a WWAN interface according to the phone number of the peer UE which is known beforehand (step S130). If the WWAN interface of the handover receiver UE is available, the handover receiver UE can decide whether to accept the WWAN call according to the phone number of the handover initiator UE shown in the received WWAN call. If the WWAN call is accepted, the two UEs continue communication via their respective WWAN interfaces (step S180).

In FIG. 2A, the handover initiator UE sends a WWAN call during the handover process. In practical applications, the handover receiver UE may send the WWAN call as well, as shown in FIG. 2B. In FIG. 2B, the handover initiator UE communicating with the peer UE via the WLAN interface (step S30) first send a handover request to the handover receiver UE via the WLAN interface, to request to communicate via the WWAN interface (step S50). If the handover receiver UE agrees to transfer to communicate via the WWAN interface, it sends a handover confirmation message to the handover initiator UE via the WLAN interface (step S70). Then, the handover receiver UE sends a WWAN call via the WWAN interface according to the known phone number of the handover initiator UE. If the handover initiator UE decides to accept the WWAN call according to the phone number in the received WWAN call, the two UE can continue communication via the WWAN interfaces (step S180).

In the two handover processes transferring from WLAN to WWAN as shown in FIG. 2A and FIG. 2B, either the handover initiator UE or the handover receiver UE may act as the party for receiving the WWAN call during the handover process and need to determine whether the WWAN call is from its peer UE who performs WLAN communication with it according to the identification information of the peer UE, such as phone number or the like, included in the received WWAN call. The phone number of a UE may identify the UE uniquely, so it's safe to validate the identity of the UE originating the WWAN call in this way.

In some cases, however, a WWAN system such as GSM, GPRS, or 3G provides a scheme called as CLIR (Calling Line Identification Restriction) and COLR (Connected Line Identification Restriction) to protect the privacy of the calling party. Alternatively, the WWAN system may provide identification information different from that of the calling party, such as an inveracious telephone number, so that the called party cannot get the identification information of the calling party. Furthermore, when interconnection is made between networks of different operators or in different regions, it's also likely to conceal the telephone number of the calling party from the called party or only display an inveracious telephone number. For the above two cases, during the handover as shown in FIG. 2A and FIG. 2B, a UE having received a WWAN call cannot validate the identity of the UE sending the WWAN call, thus it is likely to cause handover failure or provide a possibility for a third party to intercept or wire tap the call.

It is, therefore, necessary to provide a method and apparatus applied to identification for handover between two wireless communication networks, which guarantees facilitation of the handover process between wireless networks even if the called UE cannot determine the identity of the call initiator according to identification information such as phone number and the like of the calling UE.

### OBJECT AND SUMMARY OF THE INVENTION

An object of the present invention is to provide a method and apparatus applied to identify identity during handover between wireless networks. With this method and apparatus, during the period when a UE transfers from one wireless network to another wireless network, it needn't validate the identity of the sender UE of a call according to the identification information contained in the received call, thus facilitating the handover between two wireless networks even in a system providing CLIR and COLR mechanisms or in the case of not providing identification information of the calling party due to interconnection between different networks.

To fulfill the above objects, according to one aspect of the present invention, the present invention provides a method to be executed in a first UE (User Equipment), applied to identification for handover from a current serving network to a target network, comprising the steps of: acquiring handover status information for a second UE in communication with it; and sending identity confirmation information to the second UE according to the handover status information so that the second UE can validate the first UE's identity, wherein the handover status information and the identity confirmation information are transmitted via different networks.

According to this aspect of the present invention, there is provided with a method to be executed in a second UE, applied to identification for handover from a current serving network to a target network, comprising the steps of: exchanging information with a first UE in communication with it so that the first UE can acquire handover status information for the second UE; and receiving identity confirmation information from the first UE, so as to validate the identity of the first UE, wherein the handover status information and the identity confirmation information are transmitted via different networks.

According to another aspect of the present invention, the present invention provides a first UE capable of performing handover between networks, comprising: a current serving network interface, for communicating with a second UE via a current serving network; a target network interface, for sending a handover call to the second UE via a target network to be transferred to, and for communicating with the second UE after transferring to the target network; a sending unit, for sending information to the second UE via the current serving network interface or the target network interface, to request the second UE to accept the handover call; a receiving unit, for acquiring handover status information for the second UE in communication with it via the current serving network interface or the target network interface; and a detecting unit, for detecting the handover status information received by the receiving unit indicating whether the second UE permits handover; wherein the sending unit sends identity confirmation information to the second UE via the current serving network interface or the target network interface according to the detection result of the detecting unit, so that the second UE can validate its identity; and wherein the handover status information and the identity confirmation information are transmitted respectively via different network interfaces.

Another aspect of the present invention provides a second UE capable of performing handover between networks, comprising: a current serving network interface, for communicating with a first UE via a current serving network; a target network interface, for receiving a handover call from the first UE via the target network to be transferred to and for communicating with the first UE after transferring to the target network; a receiving unit, for receiving handover call request information from the first UE via the current serving network interface or the target network interface; a determining unit, for determining whether handover is permitted according to the handover call request information received by the receiving unit; and a sending unit, for sending handover status information to the first UE via the current serving network interface or the target network interface according to the determination result of the determining unit; wherein the receiving unit receives identity confirmation information from the first UE via the current serving network interface or the target network interface, to validate the identity of the first UE; and wherein the handover status information and the identity confirmation information are transmitted via different network interfaces respectively.

Other objects and attainments together with a fuller understanding of the invention will become apparent and appreciated by referring to the following descriptions and claims taken in conjunction with the accompanying drawings.

### BRIEF DESCRIPTION OF THE DRAWINGS

Detailed descriptions will be given below to specific embodiments of the present invention in connection with accompanying drawings, in which:

FIG. 1 illustrates a mixed application of WLAN (Wireless Local Area Network) and WWAN (Wireless Wide Area Network);

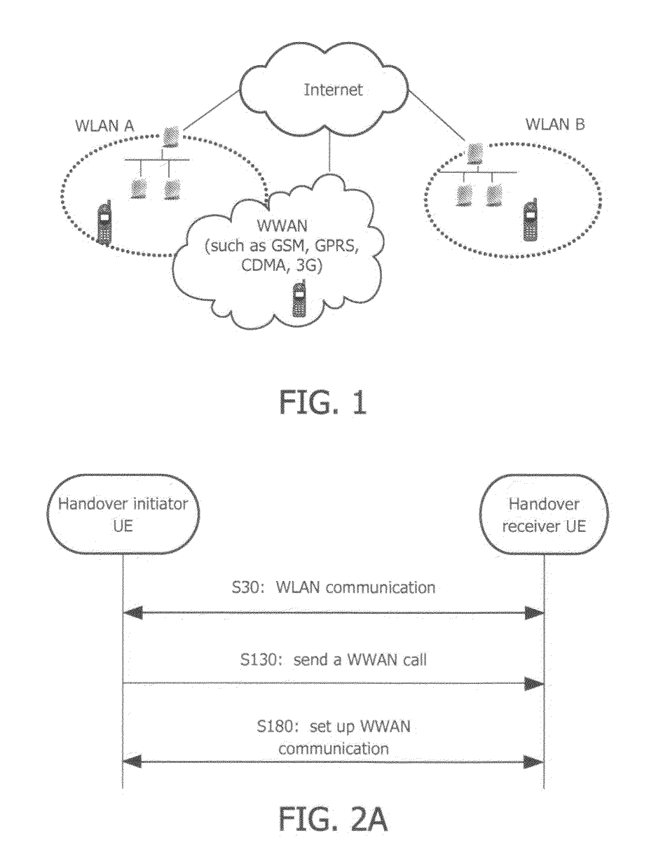

FIG. 2A and FIG. 2B illustrate two conventional methods for performing handover from WLAN to WWAN;

FIG. 3 is a flowchart for validating the identity of the calling UE of the handover call during the handover from WLAN to WWAN according to a first embodiment of the present invention;

FIG. 4 is a flowchart for validating the identity of the calling UE of the handover call during the handover from WLAN to WWAN according to a second embodiment of the present invention;

FIG. 5 is a flowchart for validating the identity of the calling UE of the handover call during the handover from WLAN to WWAN according to a third embodiment of the present invention;

FIG. 6 is the block diagram showing a UE capable of performing handover from WLAN to WWAN according to one embodiment of the present invention.

Throughout all the above drawings, like reference numerals will be understood to refer to like, similar or corresponding features or functions.

### DETAILED DESCRIPTION OF THE INVENTION

During a handover procedure of transferring from a wireless network (such as WLAN) currently providing services to a target wireless network (such as WWAN), the handover initiator UE (or the handover receiver UE) sends a call (referred as a handover call) to its peer UE via the network interface of the target wireless network, so as to establish a communication link via the target wireless network. According to the methods applied to identification for handover between two wireless networks in the present invention, the handover initiator UE (or handover receiver UE) may send confirmation information to the peer UE via the network interface of the current serving wireless network after or before the handover call is sent out, to confirm that the handover call is originated from the handover initiator UE (or the handover receiver UE). In this way, the UE having received the handover call may readily determine whether to accept the handover call or not according to the confirmation information. If the handover call is accepted after determination, the two UEs may establish communication link via the target wireless network. With the identification method proposed in the present invention, the two UEs can perform the handover procedure transferring from one wireless network to another successfully even if the called UE of the handover call cannot obtain the identification information of the calling UE.

The following description will be given to the identification method proposed in the present invention, taking as an example the handover procedure transferring from WLAN to WWAN, wherein WLAN is the current serving network that provides service to the ongoing communication between the UEs, and WWAN is the handover target network that the UEs wish to transfer to and provides communication services between the UEs after the handover. In the following description to specific embodiments of the present invention, those skilled in the art should appreciate that WLAN may be replaced with other wireless network technologies, such as Bluetooth, UWB and so on, and similarly, WWAN may be replaced with other wireless networks.

It is to be noted here that the embodiments of the present invention are focused on how to validate the identity of the calling UE of the handover call (WWAN handover call) sent via WWAN during the handover procedure transferring from WLAN to WWAN. Accordingly, the UE sending the WWAN handover call is termed as the calling UE of the WWAN handover, abbreviated as calling UE (or the first UE), and the UE receiving the WWAN handover call is termed as the called UE of the WWAN handover call, abbreviated as called UE (or the second UE) hereafter. A calling UE and a called UE of a WWAN handover call both may be the handover initiator UE or the handover receiver UE respectively.

Furthermore, in order not to obscure the objects of the invention, the initiation section is omitted from the following embodiments and the description starts directly with the fact that a calling UE of a WWAN handover call attempts to send the WWAN handover call.

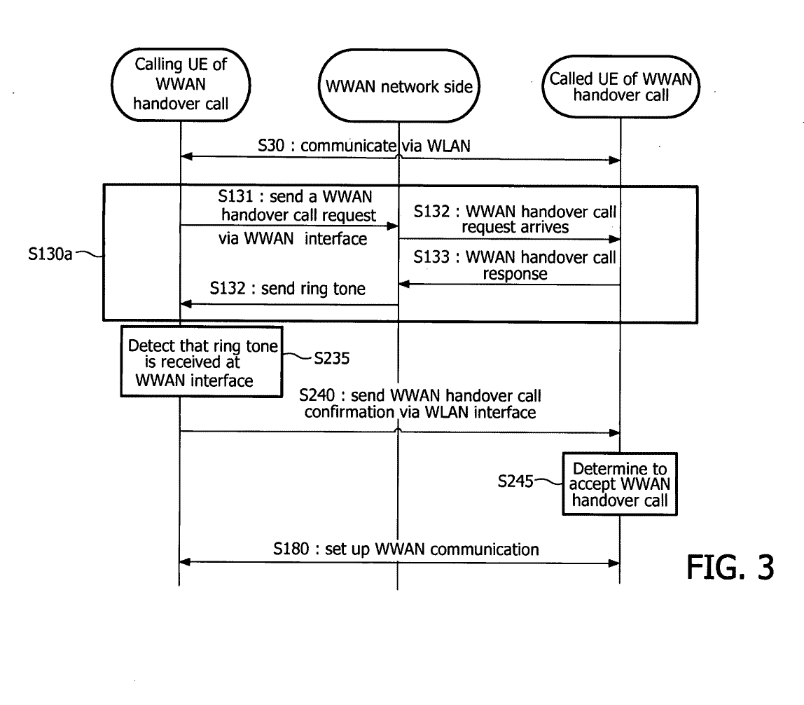

A detailed description will be given to the methods applied to identification for handover between wireless networks as proposed in the present invention, taken in conjunction with three specific embodiments as shown in FIG. 3 to FIG. 5.

### Embodiment 1

FIG. 3 illustrates a flowchart for validating the identity of the calling UE of the handover call during the handover from WLAN to WWAN according to a first embodiment of the present invention.

In the flowchart shown in FIG. 3, if the calling UE of the WWAN handover call decides or agrees to transfer from WLAN to WWAN, the calling UE sends a WWAN handover call to the called UE via the WWAN interface. Subsequently, if the calling UE receives a ring tone sent by the WWAN, it sends confirmation information to the called UE via WLAN interface, to inform the called UE that the received WWAN handover call is originated from the calling UE, and the detailed procedure will be described hereafter.

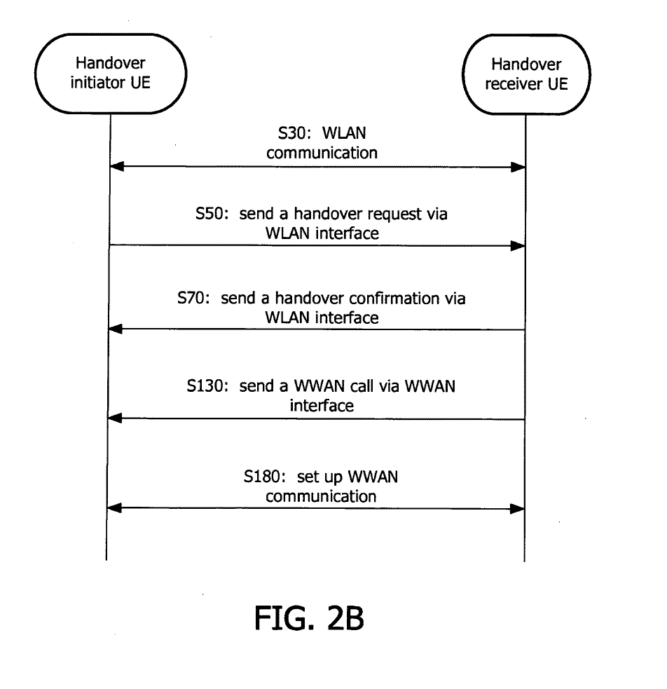

Similar to FIG. 2A and FIG. 2B, in the case of communicating with the peer UE via a WLAN interface, the calling UE of the WWAN handover call sends a WWAN handover call to the called UE via the WWAN interface (step S130a). FIG. 3 illustrates the information transmitting procedure for sending a WWAN handover call in a common circumstance. As shown in FIG. 3, the calling UE sends a WWAN handover call request to the WWAN network side (step S131), and the WWAN handover call request is forwarded via the WWAN to the WWAN interface of the called UE (step S132). Then, the WWAN network side receives response information from the called UE (step S133). At this time, if the response information indicates that the WWAN interface of the peer UE is available, the WWAN network side sends to the calling UE information, such as ring tone or the like, to indicate that the WWAN interface of the peer UE is available (step S134). If the response information indicates that the WWAN interface of the called UE is not available, the WWAN network side sends to the calling UE a busy tone, rejection information, or other information indicating that the WWAN interface of the peer UE is not available.

Next, if the calling UE detects the ring tone instead of busy tone or rejection information at the WWAN interface (step S235), indicating the called UE permits to accept of the handover call, the calling UE sends a WWAN handover call confirmation information to the called UE via the WLAN interface, to inform the called UE that the newly received WWAN handover call is originated from the calling UE (step S240). To ensure that the called UE can receive the confirmation information, the calling UE may send the WWAN handover call confirmation information repeatedly or periodically as long as it detects the ring tone at the WWAN interface. Conversely, if the calling UE detects a busy tone or rejection information at the WWAN interface indicating the called UE cannot receive the handover call, the calling UE won't send any information to the called UE.

On one hand, the called UE receives the WWAN handover call via the WWAN interface; on the other hand, it receives the WWAN handover call confirmation information from the calling UE via the WLAN interface in a short time period. Thus, the called UE can easily determine that the WWAN handover call is originated from the calling UE that sent the WWAN handover call confirmation information (step S245), and thus it accepts the WWAN handover call, to establish a WWAN communication link with the calling UE (step S180). If the called UE fails to receive the WWAN handover call confirmation information for all the while, it rejects the WWAN handover call.

### Embodiment 2

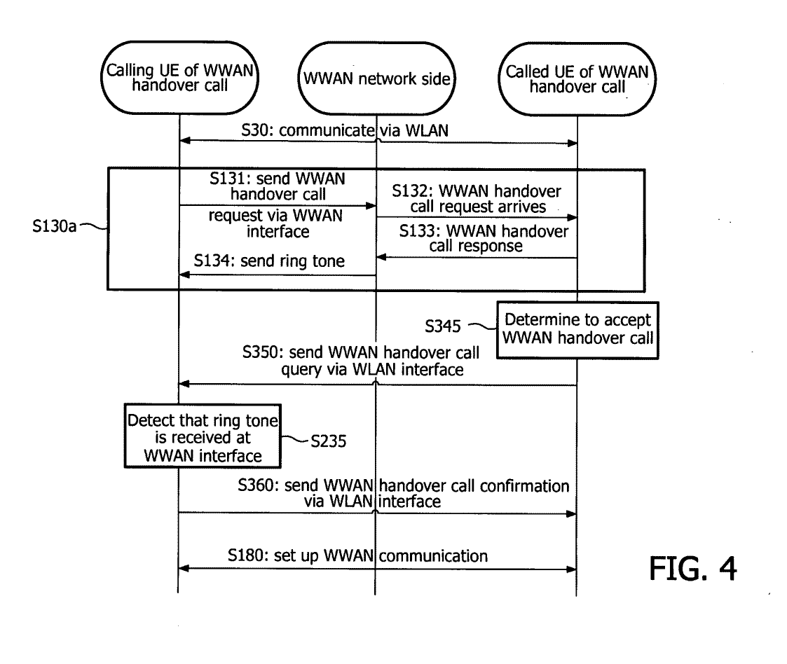

FIG. 4 illustrates a flowchart for validating the identity of the calling UE of the handover call during the handover from WLAN to WWAN according to a second embodiment of the present invention.

In the flowchart as shown in FIG. 4, if the calling UE of the WWAN handover call decides or agrees to transfer from WLAN to WWAN, the calling UE may first send a WWAN handover call to the called UE via the WWAN interface, and then, after the called UE receives the WWAN handover call, it can obtain the confirmation information for the WWAN handover call from the calling UE via the WLAN interface in form of query and reply. The detailed procedure is given as follows.

Similar to the first embodiment, the calling UE first sends a WWAN handover call to the called UE via the WWAN interface, in the case of communicating with the peer UE via the WLAN interface (step S130a, and the specific steps are S131-134).

Next, the called UE determines whether the acceptance of the WWAN handover call is permitted after receiving the WWAN handover call via the WWAN interface (step S345). For example, whether the acceptance of the WWAN handover call is permitted depends on many considerations, such as communication cost, user preference setting and so on. If the called UE permits to accept the WWAN handover call, it sends WWAN handover call query information to the calling UE via the WLAN interface, to query whether the calling UE sent the WWAN handover call (step S350). If the called UE doesn't permit to accept the WWAN handover call, it may ignore the WWAN handover call, or indicate to reject the acceptance of the WWAN handover call in the query information.

After the calling UE receives the WWAN handover call query information from the called UE via the WLAN interface, it sends WWAN handover call confirmation information (step S360) when detecting the ring tone at the WWAN interface (step S235), which is similar to the first embodiment. Otherwise, if the calling UE detects a busy tone or rejection information at the WWAN interface, it may indicate that the WWAN handover call is not sent from the calling UE in the WWAN handover call confirmation information to be sent to the called UE (step S360). If the calling UE didn't send any WWAN call in a while before receiving the WWAN handover call query information, i.e. the corresponding operation at step S130a is not performed, it may send information indicating that the WWAN handover call is not sent, or ignore the query information, which is similar to step S360.

If the called UE receives the WWAN handover call confirmation information from the calling UE via the WLAN interface, it accepts the WWAN handover call, to establish a WWAN communication link with the calling UE (step S180). Otherwise, the called UE rejects to accept of the WWAN handover call.

### Embodiment 3

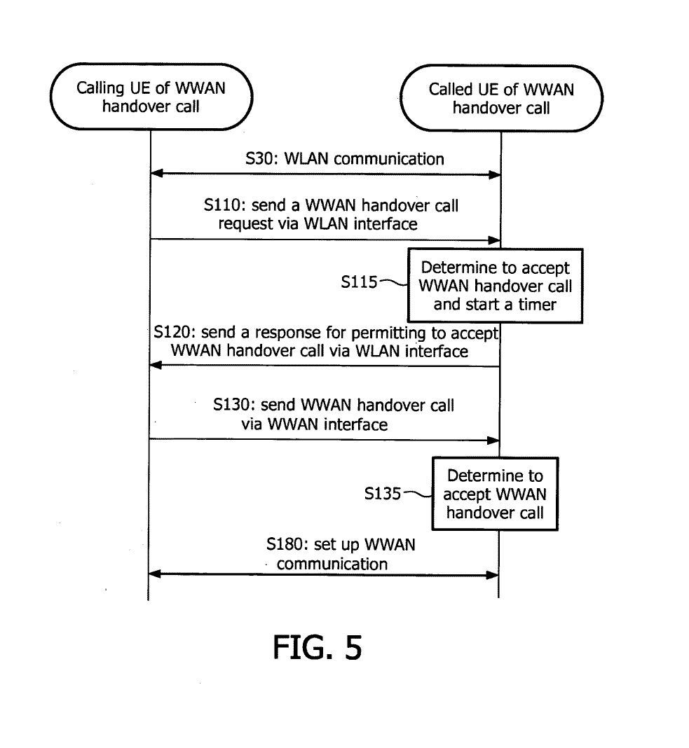

FIG. 5 is a flowchart for validating the identity of the calling UE of the handover call during the handover from WLAN to WWAN according to a third embodiment of the present invention.

In the handover procedure as shown in FIG. 5, if the calling UE of the WWAN handover call decides or agrees to transfer from WLAN to WWAN, the calling UE may send information to the called UE via the WLAN interface before sending a WWAN handover call to the called UE, to inform the called UE that the WWAN handover call to be received is originated from the calling UE. The detailed procedure is given as follows.

As shown in FIG. 5, in the case of communicating with the peer UE via the WLAN interface (step S30), before the calling UE of the WWAN handover call attempts to send a WWAN handover call via the WWAN interface, it sends WWAN handover call request information to the called UE via the WLAN interface (step S110). The WWAN handover call request information may include sending time information, to inform the called UE that it will send a WWAN handover call to the called UE in the time determined by the sending time information (such as X seconds). Optionally, the calling UE starts a timer after sending the WWAN handover call request information, so as to send the WWAN call before the timer expires. The counted time of the timer shouldn't be longer than the time determined by the sending time information, to ensure that the WWAN handover call can be sent within the time determined by the sending time information.

After the called UE receives the WWAN handover call request information from the calling UE via the WLAN interface, it determines whether the acceptance of the WWAN handover call via the WWAN interface is permitted, for example, according to whether its WWAN interface is available, communication cost, user preference setting and etc.

If the WWAN handover call is permitted to be accepted after the determination (step S115), the called UE starts a timer according to the sending time information in the received WWAN handover call request information, to wait for the WWAN handover call from the calling UE within the time period determined by the sending time information. Then, the called UE sends response information to the calling UE, indicating that the WWAN handover call is permitted to be accepted (step S120). If the determination shows that the called UE doesn't permit to accept the WWAN handover call, it sends the response information to the calling UE indicating that the WWAN handover call is not permitted to be accepted or ignores the WWAN handover call request at step S120.

The calling UE determines whether to send the WWAN handover call according to the response information received via the WLAN interface from the called UE. If the response information shows that the called UE permits to accept the WWAN handover call, the calling UE sends the WWAN handover call to the calling UE via the WWAN interface within the time determined by the sending time information, according to known information about the called UE, such as phone number, that is, send again a handover call request to the called UE via the WWAN interface, to validate its identification (step S130). Otherwise, the calling UE ignores the WWAN handover call request, and continues communication with the called UE via the WLAN interface.

After the called UE starts the timer, it keeps monitoring the WWAN interface to see whether the WWAN handover call is received. If the called UE receives the WWAN handover call before the timer expires, i.e. within the time period determined by the sending time information, the WWAN handover call is considered to be originated from the calling UE and the WWAN call is accepted (step S135), thus to establish a WWAN communication link with the calling UE via the WWAN interface (step S180).

If the WWAN handover call is not received within the time period determined by the sending time information, for example, no WWAN call is received within the time period, the called UE continues communication with the calling UE via the WLAN interface. If the WWAN handover call is received after the time period determined by the sending time information comes to an end, the called UE considers the WWAN call is not originated from the calling UE and rejects to accept it.

If one or more WWAN calls having phone number information are received within the time period determined by the sending time information, the called UE can discern that the WWAN call is not originated from the calling UE according to the phone number information and thus rejects the WWAN call. The identification (such as phone number) information of the calling UE may be transferred to the called UE in the WWAN handover call request information at step S110, or during the preceding handover procedure.

If the calling UE fails to establish a WWAN communication with the called UE via the WWAN interface within the time period determined by the sending time information, it will ignore the WWAN handover call request and continues communication with the called UE via the WLAN interface.

In this embodiment, the time period determined by the sending time information should be more than the sum of the average delay time for the WWAN call setup in the networks of the called and the calling parities and the time required for transferring the request and response information of the WWAN handover call. Of course, the time period determined by the sending time information cannot be too large, so as to avoid intervention of a WWAN call from a possible third parity. Therefore, the margin with which the time period determined by the sending time information exceeds the sum of the above times is preferably not more than the maximum setup delay time in the WWAN network.

The procedures described in the three above embodiments can be combined to form a single procedure that is capable of validating the identification of the calling UE of the WWAN handover call more appropriately and readily. For example, before the calling UE of the WWAN handover call sends the WWAN handover call to the called UE via the WWAN interface, it may inform the called UE that a WWAN call from the calling UE will be received within a specified time period, in the way same as that described in the third embodiment. If the calling UE sends the WWAN call after the specified time rather than within the specified time, it may send the WWAN call confirmation information to the called UE via the WLAN interface after sending the WWAN call, in the way same as that described in the first embodiment. If the called UE fails to receive the confirmation information, the called UE obtains the WWAN handover confirmation information from the calling UE in form of query and reply, in the way same as that described in the second embodiment.

Furthermore, those skilled in the art shall appreciate that the solutions described in the above embodiments can be of any combination and the implementation of the present invention is not limited to the three specific embodiments as set forth herein.

Detailed descriptions are given to three embodiments of the present invention in connection with FIGS. 3-5, wherein information transferred via the WLAN interface may be encapsulated into a self-defined IP packet, or a VoIP signaling packet, or in format of IM (Instant Messaging).

The above method applied to identification for handover between wireless networks as proposed in the present invention may be implemented in software, or hardware, or in combination of both.

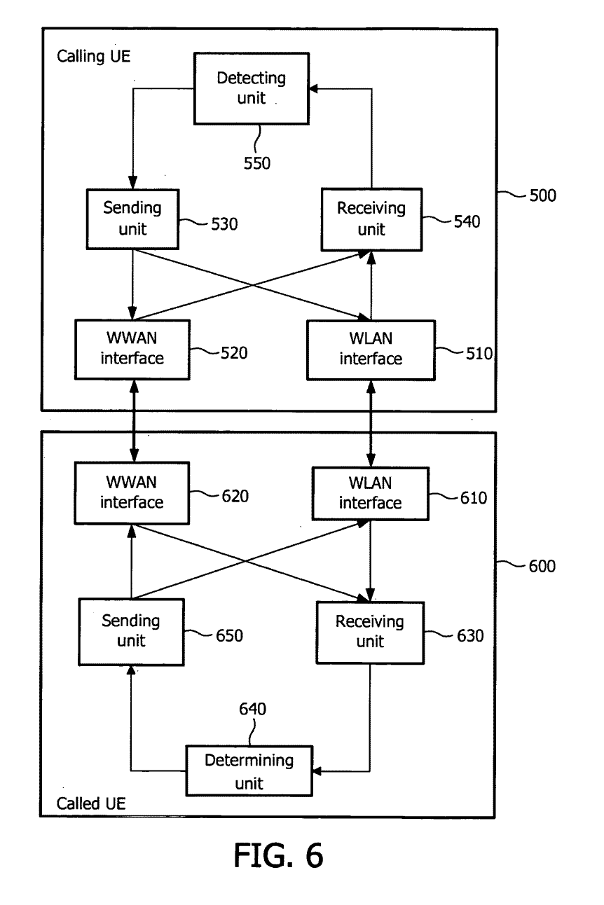

FIG. 6 illustrates the configuration of a UE capable of performing handover from WLAN to WWAN according to the present invention. As shown in FIG. 6, a calling UE 500 for a WWAN handover call comprises a WLAN interface 510 for communicating with a called UE via a WLAN channel, a WWAN interface 520 for communicating with a called UE via a WWAN channel, a sending unit 530 for sending information to the called UE via

WLAN interface 510 or WWAN interface 520, to request the called UE to accept the handover call, a receiving unit 540 for receiving handover status information from the called UE via the WLAN interface or the WWAN interface, and a detecting unit 550 for detecting that the handover status information received by the receiving unit 540 indicates whether the called UE permits the handover. According to the detection result of the detecting unit 550, sending unit 530 sends identification confirmation information to the called UE via an interface different from the one via which the handover status information is received (WLAN interface or WWAN interface), for the called UE to validate its identity. If the called UE accepts the handover call through identification, the calling UE 500 may communicate with the called UE via the WWAN interface 520.

As shown in FIG. 6, the called UE 600 of the WWAN handover call comprises a WLAN interface 610 for communicating with the calling UE via the WLAN channel, a WWAN interface 620 for communicating with the calling UE via the WWAN channel, a receiving unit 630 for receiving the information requesting for acceptance of the handover call from the calling UE, a determining unit 640 for determining whether handover is permitted according to the information received by the receiving unit 630, a sending unit 550 for sending handover status information to the calling UE via the WLAN interface 610 or the WWAN interface 620 according to the determination result of the determining unit 630, to inform the calling UE whether it permits the handover. Wherein, the receiving unit 630 further receives the identity confirmation information from the calling UE via an interface different from the one via which the handover status information is sent (WLAN interface 610 or WWAN interface 620), so as to validate the identity of the calling UE. If the called UE 600 accepts the handover call through identification, it may communicate with the calling UE via the WWAN interface 620.

### ADVANTAGEOUS EFFECTS OF THE INVENTION

Descriptions are given above to the methods applied to identification for handover between wireless networks as proposed in the present invention, taking WLAN and WWAN as example. With the methods applied to identification for handover between wireless networks as proposed in the present invention, the calling UE of an WWAN handover call can know whether the received handover call of a target wireless network is originated from a peer UE (calling UE) in communication with it via the network interface of the wireless network currently providing services. As such, even if the received handover call doesn't contain the identification information of the calling party, for example, phone number, or contains an inveracious phone number, the identity of the calling party sending the handover call may be validated. In this way, a handover can be readily implemented by transferring from one wireless network to another, in the wireless system providing CLIR and COLR, in the system providing inveracious phone number of the calling party, or in the case of not providing identification information of the calling UE when interconnecting between networks of different operators or in different regions.

Furthermore, in the method as proposed in the present invention, the calling UE of the handover call may validate whether the handover call reaches the called UE by detecting whether receives the information (such as ring tone or the like) indicating whether the network interface of the target wireless network of the called UE is available and sent by the target wireless network. This method is easy for implementation accordingly.

It is to be understood by those skilled in the art that various improvement and modifications can be made to the method and apparatus applied to identification for handover between wireless networks as disclosed in the present invention without departing from the basis of the present invention, the scope of which is to be defined by the attached claims herein.

1. A method to be executed in a first UE (User Equipment), applied to identification for handover from a current serving network to a target network, comprising the steps of:
(a) acquiring handover status information for a second UE communicating with the first UE; and
(b) sending identity confirmation information to the second UE according to the handover status information so as to the second UE validates the first UE's identity, wherein different networks are employed at step (a) and step (b).

2. The method of claim 1, wherein step (a) comprises:
(a1) sending handover call request information to the second UE via the target network; and
(a2) receiving, from the target network, the handover status information for the second UE via the target network.

3. The method of claim 2, wherein the handover status information for the second UE includes handover permission information or handover rejection information.

4. The method of claim 3, wherein the handover permission information is ring tone and the handover rejection information is one of information of busy tone, call unreachable or call rejection.

5. The method of claim 4, wherein the identity confirmation information of the step (b) comprises call confirmation information sent via the current serving network.

6. The method of claim 5, further comprising a step of, before step (b):
receiving handover call query information from the second UE via the current serving network.

7. The method of claim 1, wherein step (a) comprises:
(a1) sending handover call request information to the second UE via the current serving network; and
(a2) receiving the handover status information from the second UE via the current serving network, the handover status information including handover permission information or handover rejection information.

8. The method of claim 7, wherein the identity confirmation information of the step (b) is a handover call request sent again via the target network within a certain period.

9. The method of claim 1, wherein the current serving network is WLAN and the target network is WWAN.

10. A method to be executed in a second UE, applied to identification for handover from a current serving network to a target network, comprising the steps of:
(a) exchanging information with a first UE in communication with the second UE so as to the first UE acquires handover status information for the second UE; and
(b) receiving identity confirmation information from the first UE, so as to validate the identity of the first UE, wherein different networks are employed at step (a) and step (b).

11. The method of claim 10, wherein step (a) comprises:
(a1) receiving, via the target network, handover call request information from the first UE forwarded by the target network; and
(a2) sending the second UE's handover status information to the first UE via the target network.

12. The method of claim 11, wherein the handover status information for the second UE includes handover permission information or handover rejection information.

13. The method of claim 12, wherein the identity confirmation information of the step (b) comprises call confirmation information sent via the current serving network.

14. The method of claim 13, further comprising a step of, before step (b): sending handover call query information to the first UE via the current serving network.

15. The method of claim 10, wherein step (a) comprises:
(a1) receiving handover call request information from the first UE via the current serving network; and
(a2) sending handover status information to the first UE via the current serving network, the handover status information including handover permission information or handover rejection information.

16. The method of claim 15, further comprising:
starting a timer after the step (a) so as to wait for the identity confirmation information from the first UE in step (b) within a certain period.

17. The method of claim 16, wherein the identity confirmation information in the step (b) is a handover call request sent again via the target network within a certain period.

18. The method of claim 10, wherein the current serving network is WLAN and the target network is WWAN.

19. A first UE capable of performing handover between networks, comprising:
a current serving network interface, for communicating with a second UE via a current serving network;
a target network interface, for sending a handover call to the second UE via a target network to be transferred to, and for communicating with the second UE after handover to the target network;
a sending unit, for sending information to the second UE via the current serving network interface or the target network interface, to request the second UE to accept the handover call;
a receiving unit, for acquiring handover status information for the second UE communicating with it via the current serving network interface or the target network interface; and
a detecting unit, for detecting the handover status information received by the receiving unit for indicating whether the second UE permits handover;
wherein the sending unit sends identity confirmation information to the second UE via the current serving network interface or the target network interface according to the detection result of the detecting unit, so that the second UE validates its identity; and
wherein the handover status information and the identity confirmation information are transmitted respectively via different network interfaces.

20. The UE of claim 19, wherein
the sending unit sends the handover call request information to the second UE via the target network interface; and
the receiving unit receives the handover status information for the second UE from the target network via the target network interface.

21. The UE of claim 20, wherein, if the detecting unit detects the handover status information is ring tone, it indicates that the second UE permits handover, and if the detecting unit detects that the handover status information is one of busy tone, call unreachable or call rejection information, it indicates that the second UE doesn't permit handover.

22. The UE of claim 21, wherein the receiving unit further receives handover call query information from the second UE via the current serving network interface.

23. The UE of claim 19, wherein
the sending unit further sends handover call request information to the second UE via the current serving network interface; and
the receiving unit receives the handover status information from the second UE via the current serving network interface.

24. The UE of claim 23, wherein
the identity confirmation information is a handover call request sent again to the second UE from the sending unit via the target network interface within a certain period.

25. A second UE capable of performing handover between networks, comprising:
a current serving network interface, for communicating with a first UE via a current serving network;
a target network interface, for receiving a handover call from the first UE via the target network to be transferred to and for communicating with the first UE after transferring to the target network;
a receiving unit, for receiving handover call request information from the first UE via the current serving network interface or the target network interface;
a determining unit, for determining whether handover is permitted according to the handover call request information received by the receiving unit; and
a sending unit, for sending handover status information to the first UE via the current serving network interface or the target network interface according to the determination result of the determining unit;
wherein the receiving unit receives identity confirmation information from the first UE via the current serving network interface or the target network interface, to validate the identity of the first UE; and
wherein the handover status information and the identity confirmation information are transmitted via different network interfaces respectively.

26. The UE according to claim 25, wherein
the receiving unit receives the handover call request information from the first UE forwarded by the target network via the target network interface; and
the sending unit sends its handover status information to the target network via the target network interface.

27. The UE of claim 26, wherein the sending unit further sends handover call query information to the first UE via the current serving network interface.

28. The UE of claim 25, wherein
the receiving unit further receives the handover call request information from the first UE via the current serving network interface; and
the sending unit sends handover status information indicating whether handover call is permitted to the first UE via the current serving network interface.

29. The UE of claim 28, further comprising a timer, for waiting to receive the identity confirmation information from the first UE via the target network interface within a certain period, the identity confirmation information being the handover call request sent again.
